(19) United States
(12) Patent Application Publication
(10) Pub. No.: US 2026/0016806 A1
(43) Pub. Date: Jan. 15, 2026

(54) IDENTIFICATION METHOD OF POSITION-INDEPENDENT GEOMETRIC ERRORS IN ROTARY AXES OF FIVE-AXIS MACHINE TOOLS BASED ON BALLBAR

(71) Applicant: GUANGDONG OCEAN UNIVERSITY, Zhanjiang (CN)

(72) Inventors: Huanlao LIU, Zhanjiang (CN); Xiang LI, Zhanjiang (CN); Yulin WANG, Zhanjiang (CN)

(21) Appl. No.: 19/336,546

(22) Filed: Sep. 23, 2025

Related U.S. Application Data
(63) Continuation of application No. PCT/CN2025/105799, filed on Jun. 30, 2025.

(30) Foreign Application Priority Data
Oct. 9, 2024 (CN) 202411402230.0

(51) Int. Cl. G05B 19/408; B23Q 17/22; G01B 5/008

(52) U.S. Cl. CPC G05B 19/4086; B23Q 17/22; G01B 5/008

(57) ABSTRACT

An identification method of position-independent geometric errors in rotary axes of five-axis machine tools based on ballbar, in which a center of a cutter ball is installed at an intersection point of A-axis and C-axis centerlines; a workpiece ball is installed with an offset in X and Y directions; the two axes are controlled to move independently to switch between two measurement modes under a single installation mode; and through three installations, eight position-independent geometric errors of the two axes are identified. In the method, coordinates of the workpiece ball are calculated through inverse matrix transformation, so as to establish initial coordinates of the two balls in a reference coordinate system; a comprehensive rod-length model including installation errors is constructed based on homogeneous coordinate transformation; and simulation analysis is conducted to compare identified values with preset values.

### CROSS-REFERENCE TO RELATED APPLICATIONS

This application is a continuation of International Patent Application No. PCT/CN2025/105799, filed on Jun. 30, 2025, which claims the benefit of priority from Chinese Patent Application No. 202411402230.0, filed on Oct. 9, 2024. The content of the aforementioned application, including any intervening amendments thereto, is incorporated herein by reference in its entirety.

### TECHNICAL FIELD

This application relates to geometric error identification, and more particularly to an identification method of position-independent geometric errors in the rotary axes of five-axis machine tools based on ballbar.

### BACKGROUND

Compared to three-axis machine tools, five-axis machine tools exhibit greater flexibility, and can be used for machining complex components such as turbine blades and engine blocks. However, the two additional rotary axes introduce more geometric errors, which will affect machining accuracy of the five-axis machine tools. Measuring and identifying the rotary axis geometric errors is critical for improving the precision of the five-axis machine tools. Among the existing measurement instruments including laser trackers, touch-trigger probes, R-test measurement systems and ballbars, the ballbar has been widely adopted for the rotary axis error measurement due to its low cost, easy installation and excellent measurement stability.

Current methods for measuring position-independent geometric errors of rotary axes mainly include multi-axis coordinated measurement and single-axis motion measurement. However, for the multi-axis coordinated measurement, since it fails to fully compensate the geometric errors of a translation axis, the measurement results will be greatly affected by the geometric errors of the translation axis, thereby leading to inaccurate error identification. In contrast, the single-axis motion measurement can eliminate the influence of the translation axis errors on the rotary axis error identification and address the coupling problem between geometric errors of translation and rotary axes, thereby improving the error identification accuracy. Meanwhile, the existing ballbar-based identification methods generally involve multiple installation positions, which will increase the time consumption and measurement difficulty, thereby making the measurement process more complicated.

### SUMMARY

An object of the disclosure is to provide an identification method of position-independent geometric errors in the rotary axes of five-axis machine tools based on ballbar to overcome the defects in the prior art.

Technical solutions of the present disclosure are described as follows.

An identification method of position-independent geometric errors in rotary axes of a five-axis machine tool based on ballbar, comprising:
establishing coordinate systems in sequence based on a kinematic chain structure of a workpiece side of the five-axis machine tool; wherein the five-axis machine tool comprises three linear axes consisting of an X axis, a Y axis, and a Z axis, and two rotary axes consisting of an A axis and a C axis;
the kinematic chain structure comprises a cutter chain R-Y-X-Z-T and a workpiece chain R-A-C-W, where “R” denotes a reference position of the five-axis machine tool, “T” denotes a cutter, and “W” refers to a workpiece;
linear axes are not taken into consideration during establishment of the coordinate systems since it is only required to identify the position-independent geometric errors of the rotary axes;
and the coordinate systems are established through steps of:

establishing an A-axis coordinate system (ACS) at an intersection point between the A axis and the C axis centerlines;
establishing a C-axis coordinate system (CCS) at a center of a rotary table of the five-axis machine tool; and;
establishing a workpiece coordinate system (WCS) and a reference coordinate system (RCS), wherein the WCS coincides with the CCS, the RCS coincides with the ACS, and Z-axis centerlines of the WCS, the CCS, the RCS and the ACS are colinear; and
performing error measurement on the five-axis machine tool under three installation modes, wherein in each of the three installation modes, a cutter ball B₁ is connected to a spindle of the five-axis machine tool via a first tool cup, and a workpiece ball B₂ is fixed to the rotary table of the five-axis machine tool via a second tool cup and a magnetic base, and the error measurement is performed through steps of:
in a first installation mode of the three installation modes, controlling the A axis or the C axis to move, and measuring four position errors to obtain a first ballbar rod-length model;
in a second installation mode of the three installation modes, controlling the A axis to move, and measuring two first perpendicularity errors to obtain a second ballbar rod-length model;
in a third installation mode of the three installation modes, controlling the C axis to move, and measuring two second perpendicularity errors to obtain a third ballbar rod-length model; and
calculating eight position-independent geometric errors of the two rotary axes by fitting using a MATrix LABoratory (MATLAB) function in combination with the first ballbar rod-length model, the second ballbar rod-length model and the third ballbar rod-length model;
wherein the step of in the first installation mode, controlling the A axis or the C axis to move, and measuring the four position errors to obtain the first ballbar rod-length model is performed through steps of:
defining an initial coordinate of the cutter ball B₁ and an initial coordinate of the workpiece ball B₂ in the RCS respectively as:

$${}^{R} {P}_{B 1} = ( \begin{matrix}{e}_{x} \\ {e}_{y} \\ 0 \\ 1\end{matrix} ) , and \qquad ( 1 )$$

$${}^{R} {P}_{B 2} = ( \begin{matrix}{e}_{x} + {X}_{L} \\ {e}_{y} - {Y}_{L} \\ 0 \\ 1\end{matrix} ) ; \qquad ( 2 )$$

wherein eₓ and e_{y} represent installation errors of a center of the cutter ball B₁ in X and Y directions of the RCS, respectively; and X_{L} and Y_{L} represent offsets of a center of the workpiece ball B₂ with respect to the center of the cutter ball B₁ in the X direction and the Y direction, respectively;
in a case that only the A axis is controlled to move, performing circular motion of the workpiece ball B₂ about the A axis, and defining an actual transformation matrix from the ACS to the RCS as:

$${}_{A}^{R} T = [ \begin{matrix}1 & - {S}_{z a} & {S}_{y a} & 0 \\ {S}_{z a} & 1 & 0 & {δ}_{y a} \\ - {S}_{y a} & 0 & 1 & {δ}_{z a} \\ 0 & 0 & 0 & 1\end{matrix} ] \cdot [ \begin{matrix}1 & 0 & 0 & 0 \\ 0 & cos A & - s in A & 0 \\ 0 & sin A & cos A & 0 \\ 0 & 0 & 0 & 1\end{matrix} ] ; \qquad ( 3 )$$

calculating an initial coordinate of the workpiece ball B₂ in the ACS through inverse matrix transformation as:

$${}^{A} {P}_{B 2} = {}_{A}^{R} {T}^{- 1} \cdot {}^{R} {P}_{B 2} ; \qquad ( 4 )$$

obtaining an actual coordinate of the workpiece ball B₂ in the RCS through coordinate matrix transformation as:

$${}^{R} {P}_{B 2 \_ actual} = {}_{A}^{R} T \cdot {}^{A} {P}_{B 2} ; \qquad ( 5 )$$

keeping the cutter ball B₁ fixed during the error measurement, such that a coordinate of the cutter ball B₁ in the RCS remains unchanged;
substituting the initial coordinate of the cutter ball B₁ and the actual coordinate of the workpiece ball B₂ into equations (6), (10), (13) and (16) followed by simplification and neglection of higher-order error terms, so as to obtain an actual length L_{A1} of the ballbar as:

$${L}_{A 1} = \vert {B}_{1} {B}_{2} \vert = \vert {}^{R} {P}_{B 2 \_ actual} - {}^{R} {P}_{B 1} \vert = \sqrt{\begin{matrix}{[ {X}_{L} + {Y}_{L} \cdot ( {S}_{za} \cdot cos A - {S}_{ya} \cdot sin A - {S}_{za} ) ]}^{2} + \\ [ {δ}_{ya} + {X}_{L} \cdot {S}_{za} - {e}_{y} + ( {δ}_{za} - {X}_{L} \cdot {S}_{ya} ) \cdot \\ {sin A - ( {δ}_{ya} + {Y}_{L} + {X}_{L} \cdot {S}_{za} - {e}_{y} ) \cdot cos A ]}^{2} + \\ [ {δ}_{za} + {X}_{L} \cdot {S}_{ya} - ( {δ}_{za} - {X}_{L} \cdot {S}_{ya} ) \cdot cos A \\ {( {δ}_{ya} + {Y}_{L} + {X}_{L} \cdot {S}_{za} - {e}_{y} ) \cdot sin A ]}^{2}\end{matrix}} ; \qquad ( 6 )$$

in a case that only the C axis is controlled to move, performing circular motion of the workpiece ball B₂ about the C axis, and defining an actual transformation matrix from the CCS to the ACS as:

$${}_{C}^{A} T = [ \begin{matrix}1 & 0 & {S}_{yc} & {δ}_{xc} \\ 0 & 1 & - {S}_{xc} & {δ}_{yc} \\ - {S}_{yc} & {S}_{xc} & 1 & 0 \\ 0 & 0 & 0 & 1\end{matrix} ] \cdot [ \begin{matrix}cos C & - s in C & 0 & 0 \\ sin C & cos C & 0 & 0 \\ 0 & 0 & 1 & - {Z}_{A C} \\ 0 & 0 & 0 & 1\end{matrix} ] ; \qquad ( 7 )$$

wherein Z_{AC} indicates a distance between origins of the ACS and the CCS; δ_{ya} and δ_{za} represent position deviations of the A axis centerline along a Y_{R} direction and a Z_{R} direction of the RCS of the five-axis machine tool, respectively, where Y_{R} and Z_{R} denote Y-axis and Z-axis directions in the RCS; S_{ya} and S_{za} denote perpendicularity errors of the A axis centerline relative to a Y_{R} axis and a Z_{R} axis, respectively; δ_{xc} and δ_{yc} represent position deviations of the C axis centerline along X_{A} and Y_{A} directions of the ACS, respectively, where X_{A} and Y_{A} denote X-axis and Y-axis directions in the ACS; and S_{xc} and S_{yc} denote perpendicularity errors of the C axis centerline relative to an X_{A} axis and a Y_{A} axis, respectively;
calculating an initial coordinate of the workpiece ball B₂ in the CCS as:

$${{}^{C} {P}_{B 2} = {(}_{A}^{R} T \cdot {}_{C}^{A} T )}^{- 1} \cdot {}^{R} {P}_{B 2} ; \qquad ( 8 )$$

calculating the actual coordinate of the workpiece ball B₂ in the RCS as:

$${}^{R} {P}_{B 2 \_ actual} {=}_{A}^{R} T \cdot {}_{C}^{A} T \cdot {}^{C} {P}_{B 2} ; \qquad ( 9 )$$

and
obtaining an actual length L_{C1} of the ballbar based on the initial coordinate of the cutter ball B₁ and the actual coordinate of the workpiece ball B₂ as:

$${L}_{C 1} = \vert {B}_{1} {B}_{2} \vert = \vert {}^{R} {P}_{B 2 \_ actual} - {}^{R} {P}_{B 1} \vert = \sqrt{\begin{matrix}{[ {δ}_{xc} - {e}_{x} + ( {δ}_{ya} + {δ}_{yc} + {Y}_{L} - {e}_{y} ) \cdot sin C - ( {δ}_{xc} - {X}_{L} - {e}_{x} ) \cdot cos C ]}^{2} + \\ [ {δ}_{ya} + {δ}_{yc} - {e}_{y} - ( {δ}_{ya} + {δ}_{yc} + {Y}_{L} - {e}_{y} ) \cdot \\ {cos C - ( {δ}_{xc} - {X}_{L} - {e}_{x} ) \cdot sin C ]}^{2} + \\ [ {X}_{L} \cdot {S}_{xc} \cdot sin C + {X}_{L} \cdot ( {S}_{ya} + {S}_{yc} ) \cdot ( 1 - cos C ) + {Y}_{L} \cdot {S}_{xc} \cdot \\ {( 1 - cos C ) - {Y}_{L} \cdot ( {S}_{ya} + {S}_{yc} ) \cdot sin C ]}^{2}\end{matrix}} ; \qquad ( 10 )$$

the step of in the second installation mode, controlling the A axis to move, and measuring the two first perpendicularity errors to obtain the second ballbar rod-length model is performed through steps of:
in a case that only the A axis is controlled to move, due to a change in an installation position of the ballbar, changing the initial coordinate of the cutter ball B₁ and the initial coordinate of the workpiece ball B₂ respectively into:

$${}^{R} {P}_{B 1} = ( \begin{matrix}{e}_{x} + l \\ {e}_{y} \\ 0 \\ 1\end{matrix} ) , and \qquad ( 11 )$$

$${}^{R} {P}_{B 2} = ( \begin{matrix}{e}_{x} + l \\ {e}_{y} - L \\ 0 \\ 1\end{matrix} ) ; \qquad ( 12 )$$

wherein I denotes a distance from the center of the cutter ball B₁ to the C axis centerline, and L denotes a nominal length of the ballbar;
calculating the actual coordinate of the workpiece ball B₂ in the RCS in the same way as the first installation mode to obtain an actual length L_{A2} of the ballbar as:

$${L}_{A 2} = \sqrt{{[ L ( {S}_{𝓏 a} \cdot cos A - {S}_{ya} \cdot sin A - {S}_{𝓏 a} ]}^{2} + {[ {δ}_{ya} + l \cdot {S}_{𝓏 a} - {e}_{y} + ( {δ}_{𝓏 a} - l \cdot {S}_{ya} ) sin A - ( L + {δ}_{ya} + l \cdot {S}_{𝓏 a} - {e}_{y} ) \cdot cos A ]}^{2} + {[ {δ}_{𝓏 a} - l \cdot {S}_{ya} - ( {δ}_{𝓏 a} - l \cdot {S}_{ya} ) \cdot cos A - ( L + {δ}_{ya} + l \cdot {S}_{𝓏 a} - {e}_{y} ) \cdot sin A ]}^{2}} ; \qquad ( 13 )$$

and
the step of in the third installation mode, controlling the C axis to move, and measuring the two second perpendicularity errors to obtain the third ballbar rod-length model is performed through steps of:
only controlling the C axis to move, and defining the initial coordinate of the cutter ball B₁ and the initial coordinate of the workpiece ball B₂ respectively as:

$${}^{R} {P}_{B 1} = ( \begin{matrix}{e}_{x} \\ {e}_{y} \\ h \\ 1\end{matrix} ) , and \qquad ( 14 )$$

$${}^{R} {P}_{B 2} = ( \begin{matrix}{e}_{x} + L \\ {e}_{y} \\ h \\ 1\end{matrix} ) ; \qquad ( 15 )$$

wherein h denotes a distance from the center of the cutter ball By to the A axis centerline; and
calculating the actual coordinate of the workpiece ball B₂ in the RCS, so as to obtain an actual length Lcs of the ballbar as:

$${L}_{c 3} = \sqrt{{[ {δ}_{{x}_{c}} - {e}_{x} + h \cdot ( {S}_{{y}_{a}} + {S}_{{y}_{c}} ) + ( L + {e}_{x} - {δ}_{{x}_{c}} - h \cdot ( {S}_{{y}_{a}} + {S}_{{y}_{c}} ) ) \cdot cos C + ( {δ}_{ya} + {δ}_{yc} - {e}_{y} - h \cdot {S}_{{x}_{c}} ) \cdot sin C ]}^{2} + {[ {δ}_{{y}_{a}} + {δ}_{{y}_{c}} - {e}_{y} + h \cdot {S}_{{x}_{c}} + ( L + {e}_{x} - {δ}_{{x}_{c}} - h \cdot ( {S}_{{y}_{a}} + {S}_{{y}_{c}} ) ) \cdot sin C + ( {δ}_{ya} + {δ}_{yc} - {e}_{y} - h \cdot {S}_{{x}_{c}} ) \cdot cos C ]}^{2} + [ L ( ( {S}_{{y}_{a}} + {S}_{{y}_{c}} ) \cdot ( 1 - cos C ) + {S}_{{x}_{c}} \cdot sin C ) ]} . \qquad ( 16 )$$

Compared to the prior art, the present disclosure has the following beneficial effects.

An identification method of position-independent geometric errors in the rotary axes of five-axis machine tools based on ballbar is provided, in which the center of a cutter ball is mounted at the intersection point of the A axis and the C axis centerlines, and a workpiece ball is installed with an offset in the X and Y directions. By sequentially controlling single-axis motion of the A axis and the C axis, two measurement modes can be switched under a single installation mode. Through the three installation modes, the method enables identification of eight position-independent geometric errors of the rotary axes. The method features simple installation, eliminates the need for extension rods and rotary axis identification, and improves the efficiency of geometric error measurement.

### BRIEF DESCRIPTION OF THE DRAWINGS

In order to illustrate the technical solutions in the present disclosure more clearly, the accompanying drawings needed in the description of the embodiments will be briefly described below. Identical reference numerals in the accompanying drawings of the present disclosure denote the same or similar sampling monitoring points. It is evident that presented in the following accompanying drawings are only some embodiments of the present disclosure, instead of all embodiments. For those of ordinary skill in the art, other accompanying drawings can be obtained based on these accompanying drawings without making creative effort.

FIGS. 1A-C schematically show three installation modes in an identification method of position-independent geometric errors in the rotary axes of five-axis machine tools based on ballbar according to an embodiment of the present disclosure, where A: first installation mode; B: second installation mode; and C: third installation mode;

FIG. 2 is a structural diagram of a five-axis machine tool and coordinate systems used in the method according to an embodiment of the present disclosure;

FIGS. 3A-B are schematic diagrams illustrating definition of position-independent geometric errors, where A: A axis and B: C axis;

FIG. 4 is a schematic diagram illustrating an installation error of a cutter ball;

FIGS. 5A-C schematically show on-site measurement setups for the three installation modes, where A: first installation mode; B: second installation mode; and C: third installation mode;

FIGS. 6A-D are graphs showing ballbar length data obtained from two measurements, where A-B: A axis and C-D: C axis; and

FIGS. 7A-B are schematic diagrams illustrating predicted ballbar length errors under the three installation modes.

### DETAILED DESCRIPTION OF EMBODIMENTS

The technical solutions in the embodiments of the present disclosure will be described clearly and completely below in conjunction with the accompanying drawings. It should be noted that, unless there is a conflict, the embodiments and the features thereof described in the present disclosure may be combined with one another. The same or similar reference numerals are used throughout the accompanying drawings to refer to the same or like parts.

In this embodiment, only position-independent geometric errors of the rotary axes are measured. During the measurement process, each rotary axis is controlled to move individually, thereby reducing the influence of other axes on the error measurement.

### Example 1

Provided herein is an identification method of position-independent geometric errors in the rotary axes of five-axis machine tools based on ballbar, including the following steps.

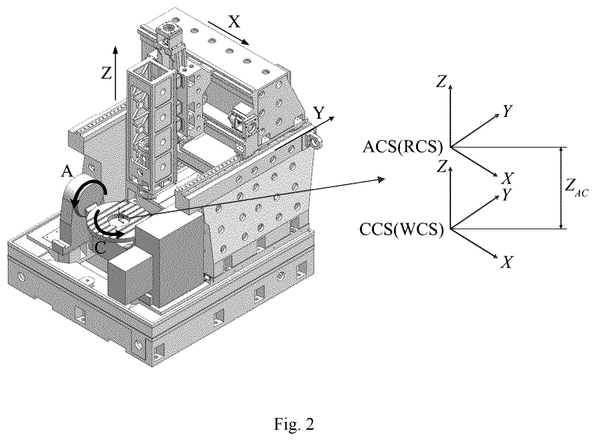

Coordinate systems are established in sequence according to a kinematic chain structure of a workpiece side of the five-axis machine tool. As shown in FIG. 2, the five-axis machine tool includes three linear axes consisting of an X axis, a Y axis, and a Z axis, and two rotary axes consisting of an A axis and a C axis. The kinematic chain structure includes a cutter chain R-Y-X-Z-T and a workpiece chain R-A-C-W. Linear axes are not taken into consideration during establishment of the coordinate systems since it is only required to identify the position-independent geometric errors of the rotary axes. As shown in FIG. 2, the coordinate systems are established through the following steps. An A-axis coordinate system (ACS) is established at an intersection point between the A axis and the C axis centerlines. A C-axis coordinate system (CCS) is established at a center of a rotary table of the five-axis machine tool. For the purpose of simplifying the modeling process, a workpiece coordinate system (WCS) and a reference coordinate system (RCS) are established, where the WCS coincides with the CCS, and the RCS coincides with the ACS, and Z-axis centerlines of the WCS, CCS, RCS, and ACS are collinear. As used herein, an expression in the form of capital letter H followed by “CS” (i.e., H+CS (ACS, WCS, CCS and RCS)) denotes the coordinate system associated with the corresponding capital letter H, where H represents one of R-Y-X-Z-T or R-A-C-W.

Error measurement is performed on the five-axis machine tool under three installation modes. In each of the three installation modes, a cutter ball B₁ is connected to a spindle of the five-axis machine tool via a first tool cup, and is installed at the intersection point of the A axis and the C axis centerlines. A workpiece ball B₂ is fixed to the rotary table of the five-axis machine tool via a second tool cup and a magnetic base.

The error measurement is performed through the following steps.

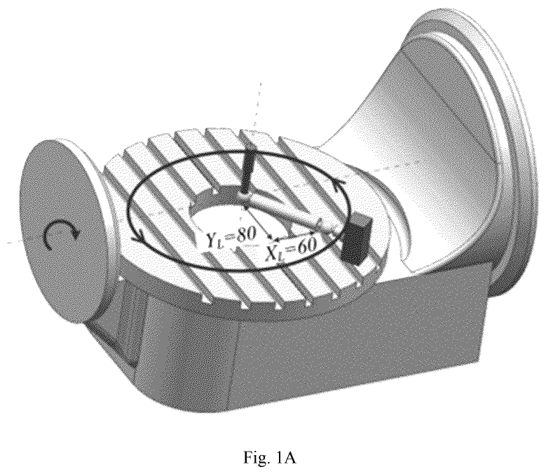

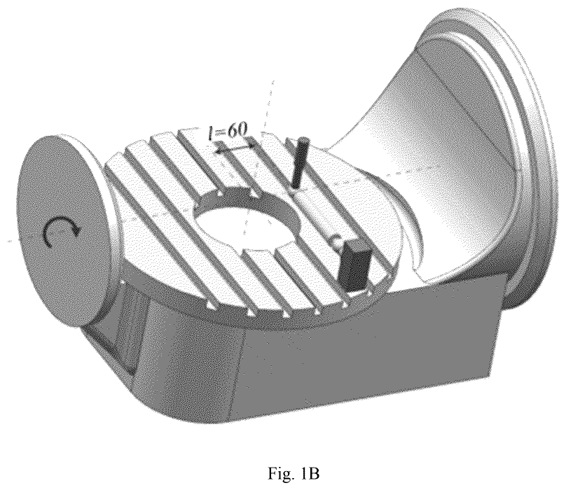

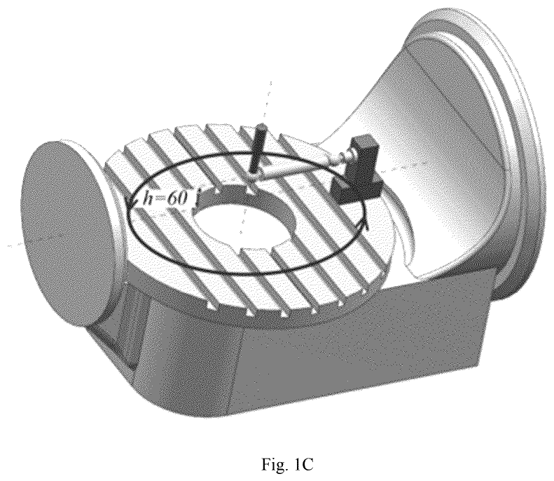

In a first installation mode of the three installation modes, the A axis or the C axis is controlled to move, and four position errors are measured to obtain a first ballbar rod-length model. As shown in FIG. 1A, a center of the cutter ball B₁ is installed at the intersection point of the A axis and the C axis centerlines. The workpiece ball B₂ is positioned 80 mm from the A-axis centerline and 60 mm from the C-axis centerline.

In a second installation mode of the three installation modes, the A axis is controlled to move, and two first perpendicularity errors are measured to obtain a second ballbar rod-length model. As shown in FIG. 1B, the center of the cutter ball B₁ is installed on the A axis centerline at a distance of 60 mm from the other axis centerline.

In a third installation mode of the three installation modes, the C axis is controlled to move, and two second perpendicularity errors are measured to obtain a third ballbar rod-length model. As shown in FIG. 1C, the center of the cutter ball B₁ is installed on the C axis centerline at a distance of 60 mm from the other axis centerline.

Eight position-independent geometric errors of the two rotary axes are calculated by fitting using a MATrix LABoratory (MATLAB) function in combination with the first ballbar rod-length model, the second ballbar rod-length model, and the third ballbar rod-length model.

According to the three rod-length models under the three installation modes, actual rod-length data of the ballbar obtained during the measurement process, together with a ballbar installation error measured using a digital micrometer and the ballbar, are substituted into the above rod-length models. Eight position-independent geometric errors of the two rotary axes are calculated by fitting using the MATLAB function.

In this embodiment, the center of the cutter ball B₁ is installed at the intersection point of the A axis and the C axis centerlines. The workpiece ball B₂ is installed with an offset in X and Y directions. Single-axis motions of the two rotary axes are sequentially controlled, enabling the switching between two measurement modes under a single installation mode. Through the three installation modes, eight position-independent geometric errors of the rotary axes are identified. This method features easy installation, requires no extension rods, and does not require identification of the rotary axis centerlines, thereby improving the efficiency of error measurement.

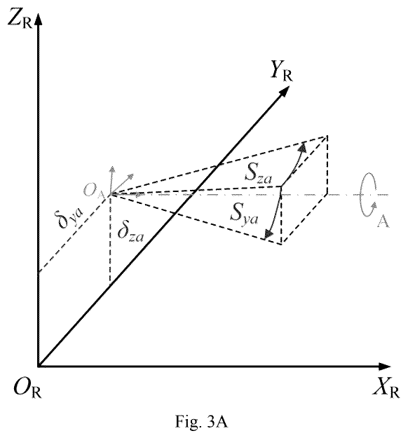

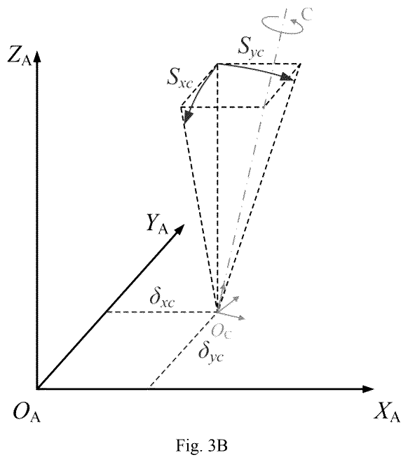

Considering that position-independent geometric errors of the rotary axes are caused by deviations in the assembly of machine tool components, which induce errors in both position and angle of the axes and affect the actual machining accuracy. A structure of the five-axis machine tool structure is shown in FIG. 2. The rotary axes consist of the A axis and the C axis, with a total of eight position-independent geometric errors. Each rotary axis includes two position errors and two perpendicularity errors, as illustrated in FIGS. 3A-B. δ_{za} and δ_{za} represent position deviations of the A axis centerline along a Y_{R} direction and a Z_{R} direction of the RCS of the five-axis machine tool, respectively. S_{ya} and S_{za} denote perpendicularity errors of the A axis centerline relative to a Y_{R} axis and a Z_{R} axis, respectively. δ_{xc} and δ_{yc} represent position deviations of the C axis centerline along an X_{A} direction and a Y_{A} direction of the ACS, respectively. S_{XC} and S_{YC} denote perpendicularity errors of the C axis centerline relative to an X_{A} axis and a Y_{A} axis, respectively.

Based on the three installation modes, initial coordinates of the cutter ball B₁ and the workpiece ball B₂, including the installation error of the ballbar, are sequentially established in the RCS. During measurement, only a single rotary axis is controlled to move, while a coordinate of the cutter ball B₁ remains unchanged. Actual initial position of the workpiece ball B₂ on the measured axis is determined by applying inverse transformation matrix. Subsequently, an actual coordinate of the workpiece ball B₂ in the RCS are determined through a homogeneous transformation matrix, ensuring that the actual coordinates of both balls B₁ and B₂ are consistent within the RCS and improving the identification accuracy of the model.

The step of in the first installation mode, controlling the A axis or the C axis to move, and measuring the four position errors to obtain the first ballbar rod-length model is performed through the following steps.

An initial coordinate of the cutter ball B₁ and an initial coordinate of the workpiece ball B₂ in the RCS are respectively defined as:

$${}^{R} {P}_{B 1} = ( \begin{matrix}{e}_{x} \\ {e}_{y} \\ 0 \\ 1\end{matrix} ) , and \qquad ( 1 )$$

$${}^{R} {P}_{B 2} = ( \begin{matrix}{e}_{x} + {X}_{L} \\ {e}_{y} - {Y}_{L} \\ 0 \\ 1\end{matrix} ) . \qquad ( 2 )$$

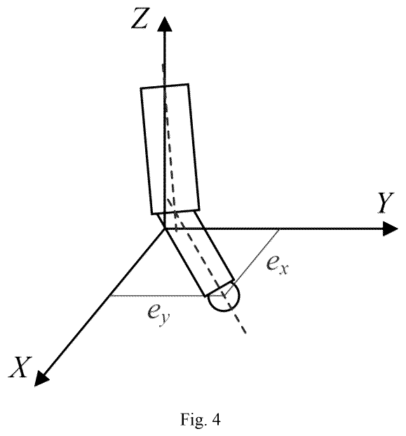

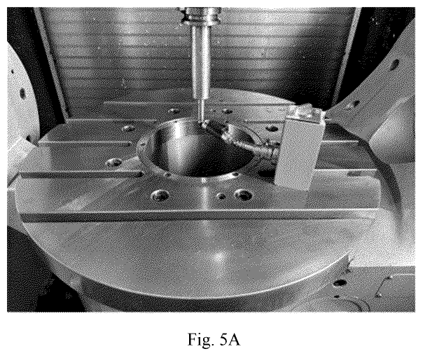

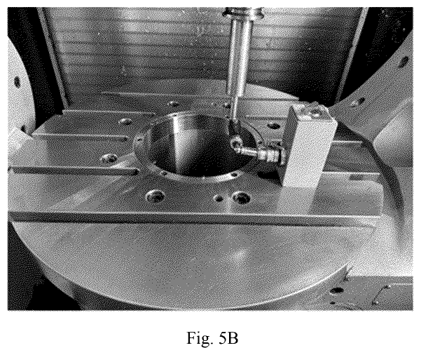

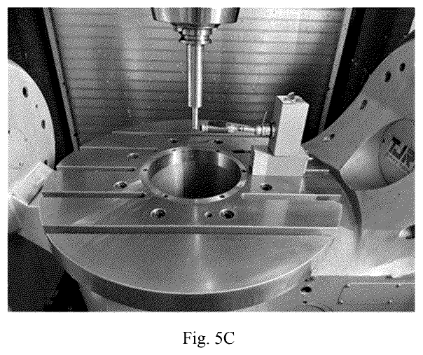

In the equations (1) and (2), eₓ and e_{y} represent installation errors of the center of the cutter ball B₁ in the X direction and the Y direction of the RCS, respectively. X_{L} and Y represent offsets of a center of the workpiece ball B₂ with respect to the center of the cutter ball B₁ in the X direction and the Y direction. As shown in FIG. 4, during installation, axes of a tool holder and the first tool cup deviate from the axis of the RCS, resulting in installation error errors eₓ and e_{y} of the center of the cutter ball in the X and Y directions. However, the installation error of the workpiece ball has a negligible effect on the variation in the ballbar length, and can be ignored in the actual measurement experiments.

In a case that only the A axis is controlled to move, circular motion of the workpiece ball B₂ about the A axis is performed. An actual transformation matrix from the ACS to the RCS is defined as:

$${}_{A}^{R} T = [ \begin{matrix}1 & - {S}_{𝓏 a} & {S}_{ya} & 0 \\ {S}_{𝓏 a} & 1 & 0 & {δ}_{ya} \\ - {S}_{ya} & 0 & 1 & {δ}_{𝓏 a} \\ 0 & 0 & 0 & 1\end{matrix} ] \cdot [ \begin{matrix}1 & 0 & 0 & 0 \\ 0 & cos A & - sin A & 0 \\ 0 & sin A & cos A & 0 \\ 0 & 0 & 0 & 1\end{matrix} ] . \qquad ( 3 )$$

An initial coordinate of the workpiece ball B₂ in the ACS is calculated through inverse matrix transformation as:

$${}^{A} {P}_{B 2} = {}_{A}^{R} {T}^{- 1} \cdot {}^{R} {P}_{B 2} . \qquad ( 4 )$$

An actual coordinate of the workpiece ball B₂ in the RCS is obtained through coordinate transformation matrix, as follows:

$${}^{R} {P}_{B 2 \_ actual} = {}_{A}^{R} T \cdot {}^{A} {P}_{B 2} . \qquad ( 5 )$$

The cutter ball B₁ is kept fixed during the error measurement, such that a coordinate of the cutter ball B₁ in the RCS remains unchanged.

The initial coordinate of the cutter ball B₁ and the actual coordinate of the workpiece ball B₂ are substituted into equations (6), (10), (13) and (16), followed by simplification and neglection of higher-order error terms, so as to obtain an actual length L_{A1} of the ballbar as follows:

$${L}_{A 1} = \vert {B}_{1} {B}_{2} \vert = {\vert}^{R} {P}_{B {2}_{-} actual} - {}^{R} {P}_{B 1} \vert = \sqrt{{[ {X}_{L} + {Y}_{L} \cdot ( {S}_{𝓏 a} \cdot cos A - {S}_{ya} \cdot sin A - {S}_{𝓏 a} ) ]}^{2} + {[ {δ}_{ya} + {X}_{L} \cdot {S}_{𝓏 a} - {e}_{y} + ( {δ}_{𝓏 a} - {X}_{L} \cdot {S}_{ya} ) \cdot sin A - ( {δ}_{ya} + {Y}_{L} + {X}_{L} \cdot {S}_{𝓏 a} - {e}_{y} ) \cdot cos A ]}^{2} + {[ {δ}_{𝓏 a} - {X}_{L} \cdot {S}_{ya} - ( {δ}_{𝓏 a} - {X}_{L} \cdot {S}_{ya} ) \cdot cos A - ( {δ}_{ya} + {Y}_{L} + {X}_{L} \cdot {S}_{𝓏 a} - {e}_{y} ) \cdot sin A ]}^{2}} . \qquad ( 6 )$$

In a case that only the C axis is controlled to move, circular motion of the workpiece ball B₂ about the C axis is performed. An actual transformation matrix from the CCS to the ACS is defined as follows:

$${}_{C}^{A} T = [ \begin{matrix}1 & 0 & {S}_{yc} & {δ}_{xc} \\ 0 & 1 & - {S}_{xc} & {δ}_{yc} \\ - {S}_{yc} & {S}_{xc} & 1 & 0 \\ 0 & 0 & 0 & 1\end{matrix} ] \cdot [ \begin{matrix}cos C & - sin C & 0 & 0 \\ sin C & cos C & 0 & 0 \\ 0 & 0 & 1 & - {Z}_{AC} \\ 0 & 0 & 0 & 1\end{matrix} ] . \qquad ( 7 )$$

In the equation (7), Z_{AC} indicates a distance between origins of the ACS and CCS.

An initial coordinate of the workpiece ball B₂ in the CCS is calculated as:

$${}^{C} {P}_{B 2} = {( {}_{A}^{R} T \cdot {}_{C}^{A} T )}^{- 1} \cdot {}^{R} {P}_{B 2} . \qquad ( 8 )$$

The actual coordinate of the workpiece ball B₂ in the RCS is calculated as:

$${}^{R} {P}_{B 2 \_ actual} = {}_{A}^{R} T \cdot {}_{C}^{A} T \cdot {}^{C} {P}_{B 2} . \qquad ( 9 )$$

An actual length L_{C1} of the ballbar is obtained based on the initial coordinate of the cutter ball B₁ and the actual coordinate of the workpiece ball B₂ as:

$${L}_{C 1} = \vert {B}_{1} {B}_{2} \vert = {\vert}^{R} {P}_{B {2}_{-} actual} - {}^{R} {P}_{B 1} \vert = \sqrt{{{[ {δ}_{xc} - {e}_{x} + ( {δ}_{ya} + {δ}_{yc} + {Y}_{L} - {e}_{y} ) sin C - ( {δ}_{xc} + {X}_{L} - {e}_{x} ) \cdot cos C ]}^{2} + [ {δ}_{ya} + {δ}_{yc} - {e}_{y} - ( {δ}_{ya} + {δ}_{yc} + {Y}_{L} - {e}_{y} ) ) \cdot cos C - ( {δ}_{xc} - {X}_{L} - {e}_{x} ) \cdot sin C ]}^{2} + {[ {X}_{L} \cdot {S}_{xc} \cdot sin C + {X}_{L} \cdot ( {S}_{ya} + {S}_{yc} ) \cdot ( 1 - cos C ) + {Y}_{L} \cdot {S}_{xc} \cdot ( 1 - cos C ) - {Y}_{L} \cdot ( {S}_{ya} + {S}_{yc} ) \cdot sin C ]}^{2}} . \qquad ( 10 )$$

The step of in the second installation mode, controlling the A axis to move, and measuring the two first perpendicularity errors to obtain the second ballbar rod-length model is performed through the following steps.

In a case that only the A axis is controlled to move, due to a change in an installation position of the ballbar, the initial coordinate of the cutter ball B₁ and the initial coordinate of the workpiece ball B₂ are respectively changed into:

$${}^{R} {P}_{B 1} = ( \begin{matrix}{e}_{x} + l \\ {e}_{y} \\ 0 \\ 1\end{matrix} ) , and \qquad ( 11 )$$

$${}^{R} {P}_{B 2} = ( \begin{matrix}{e}_{x} + l \\ {e}_{y} - L \\ 0 \\ 1\end{matrix} ) . \qquad ( 12 )$$

In the above equations (11) and (12), I denotes a distance from the center of the cutter ball B₁ to the C axis centerline, and L denotes a nominal length of the ballbar.

The actual coordinate of the workpiece ball B₂ in the RCS in the same way as the first installation mode are calculated to obtain an actual length L_{A2} of the ballbar as:

$${L}_{A 2} = \sqrt{( {[ L ( {S}_{𝓏 a} \cdot cos A - {S}_{ya} \cdot sin A - {S}_{𝓏 a} ) ]}^{2} + {[ {δ}_{ya} + l \cdot {S}_{𝓏 a} - {e}_{y} + ( {δ}_{𝓏 a} - l \cdot {S}_{ya} ) sin A - ( L + {δ}_{ya} + l \cdot {S}_{𝓏 a} - {e}_{y} ) \cdot cos A ]}^{2} + {[ {δ}_{𝓏 a} - l \cdot {S}_{ya} - ( {δ}_{𝓏 a} - l \cdot {S}_{ya} ) \cdot cos A - ( L + {δ}_{ya} + l \cdot {S}_{?? a} - {e}_{y} ) \cdot sin A ]}^{2}} . \qquad ( 13 )$$

The step of in the third installation mode, controlling the C axis to move, and measuring the two second perpendicularity errors to obtain the third ballbar rod-length model is performed through the following steps.

In a case that only the C axis is controlled to move, the initial coordinate of the cutter ball B₁ and the initial coordinate of the workpiece ball B₂ are respectively defined as:

$${}^{R} {P}_{B 1} = ( \begin{matrix}{e}_{x} \\ {e}_{y} \\ h \\ 1\end{matrix} ) , and \qquad ( 14 )$$

$${}^{R} {P}_{B 2} = ( \begin{matrix}{e}_{x} + L \\ {e}_{y} \\ h \\ 1\end{matrix} ) . \qquad ( 15 )$$

In the above equations (14) and (15), h denotes a distance from the center of the cutter ball B₁ to the A axis centerline.

The actual coordinate of the workpiece ball B₂ in the RCS is calculated, so as to obtain an actual length L_{C3} of the ballbar as follows:

$${L}_{c 3} = \sqrt{{[ {δ}_{{x}_{c}} - {e}_{x} + h \cdot ( {S}_{{y}_{a}} + {S}_{{y}_{c}} ) + ( L + {e}_{x} - {δ}_{{x}_{c}} - h \cdot ( {S}_{{y}_{a}} + {S}_{{y}_{c}} ) ) \cdot cos C + ( {δ}_{{y}_{a}} + {δ}_{{y}_{c}} - {e}_{y} - h \cdot {S}_{{x}_{c}} ) \cdot sin C ]}^{2} + {[ {δ}_{{y}_{a}} + {δ}_{{y}_{c}} - {e}_{y} - h \cdot {S}_{{x}_{c}} + ( L + {e}_{x} - {δ}_{{x}_{c}} - h \cdot ( {S}_{{y}_{a}} + {S}_{{y}_{c}} ) ) \cdot sin C - ( {δ}_{{y}_{a}} + {δ}_{{y}_{c}} - {e}_{y} - h \cdot {S}_{{x}_{c}} ) \cdot cos C ]}^{2} + {[ L ( ( {S}_{{y}_{a}} + {S}_{{y}_{c}} ) \cdot ( 1 - cos C ) + {S}_{{x}_{c}} \cdot sin C ]}^{2}} . \qquad ( 16 )$$

In this embodiment, the establishment of the workpiece side coordinate system is simplified. Meanwhile, the influence of ballbar installation errors on the identification model is taken into account during the model construction process, and the installation errors are minimized as much as possible through actual measurements. As a result, the error identification model is simplified and the identification accuracy is improved.

### Application in Practice

### 1. Simulation Verification

To further verify the accuracy of the method provided herein, simulation verification is conducted. Eight position-independent geometric errors of the A axis and the C axis are generated. Ballbar length data including installation errors are calculated based on the simulation parameters listed in Table 1 using Equations (6), (10), (13), and (16). The MATLAB fitting function is used to identify the actual position-independent geometric errors. Finally, the preset values and the identified values are compared, and the residuals of each error item are calculated.

TABLE 1
Basic Simulation Parameters

| Parameter | Value |
|---|---|
| Nominal length of ballbar | L = 100 mm |
| Offset values in three | X_{L} = 60 mm Y_{L} = 80 mm |
| measurement modes | l = 60 mm h = 60 mm |
| Rotation range of A axis | [−15°, 70°] |
| Rotation range of C axis | [0°, 360°] |
| Distance between ACS and | Z_{AC} = 50 mm |
| CCS | |

TABLE 2
simulation results

| | Preset | Identified | |
|---|---|---|---|
| Parameter | value | value | Residual |
| δ_{ya}(μm) | 12.70 | 12.70 | 0.00 |
| δ_{za}(μm) | 25.40 | 25.38 | 0.02 |
| δ_{xc}(μm) | −33.50 | −33.50 | 0.00 |
| δ_{yc}(μm) | 20.00 | 20.00 | 0.00 |
| S_{ya}(μrad) | −20.40 | −20.49 | 0.09 |
| S_{za}(μrad) | −14.60 | −14.70 | 0.10 |
| S_{xc}(μrad) | 33.60 | 33.61 | −0.01 |
| S_{yc}(μrad) | 25.00 | 25.04 | −0.04 |

The simulation results are shown in Table 2, indicating that the residuals of all error terms are small. The results demonstrate that the method provided herein has high accuracy and can accurately identify the eight position-independent geometric errors of the rotary axes.

### 2. Identification Experiment

In the measurement experiment, a nominal length of the ballbar is 100 mm. The A-axis rotates from −15° to 70°, and the C-axis rotates from 0° to 360°. After measuring the installation errors, the ballbar is installed according to the three installation modes shown in FIGS. 1A-1C. During each mode, either the A axis or the C axis is controlled to perform single-axis motion, and the ballbar length data are recorded at every 5° increment. Each set of measurements is repeated twice to reduce random errors. The actual measurement setup is shown in FIGS. 5A-C. Specifically, the A axis is controlled to move in the first and second installation modes, while the C axis is controlled to move in the first and third installation modes.

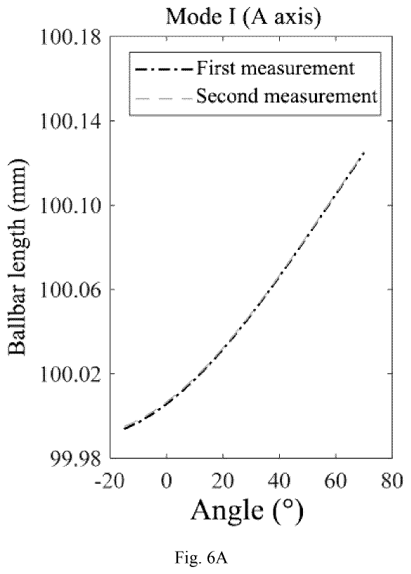

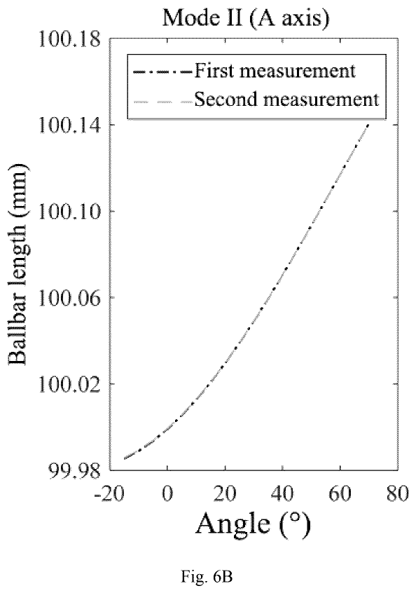

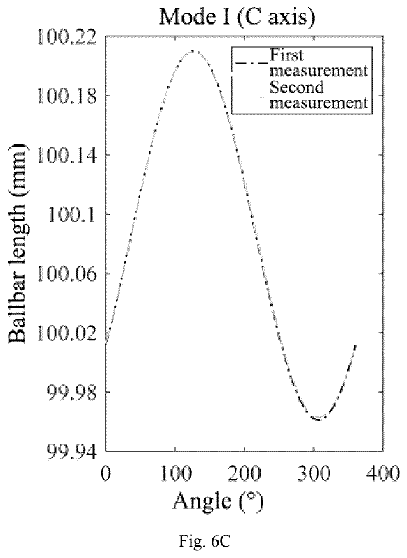

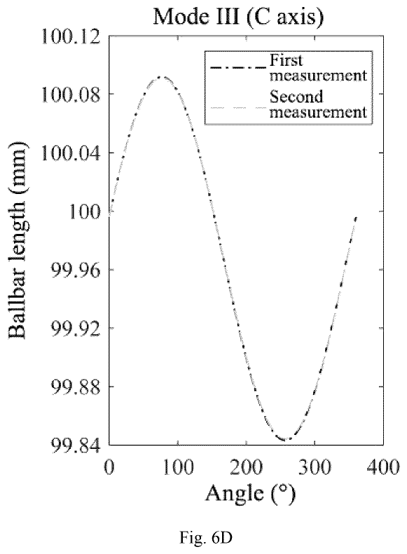

After the measurements, each pair of datasets is fitted with a curve, as shown in FIGS. 6A-D. The curves from the repeated measurements closely overlap, indicating high repeatability of the four sets of data.

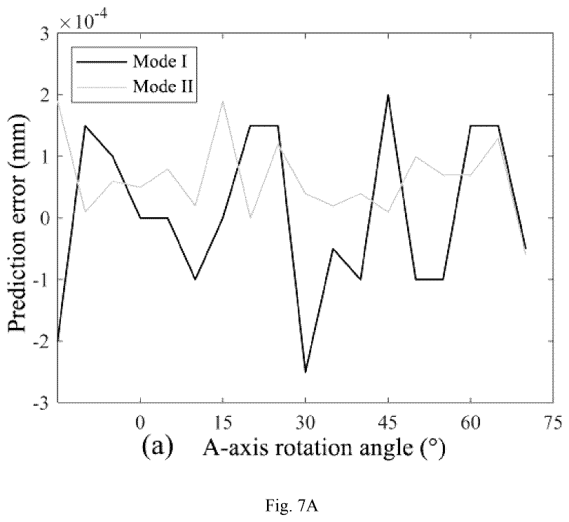

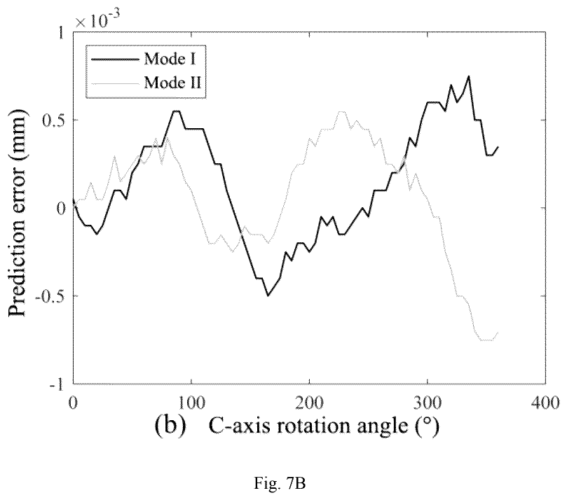

The average of the two measurements is taken. The angle and length data are then input into the MATLAB function to identify the eight position-independent geometric errors. Based on the identification results, predicted ballbar lengths are obtained under the three installation modes. The ballbar length prediction error is calculated as the difference between the predicted values and the measured values. This prediction error indirectly reflects the accuracy of the identification results. The smaller the error, the closer the identified values are to the actual errors. The prediction errors under the three installation modes are shown in FIGS. 7A-B.

The results show that the maximum prediction error among the four sets of measurements does not exceed 1 μm, which demonstrates that the method described above offers high accuracy and effectively identifies the position-independent geometric errors of the rotary axes.
(1) To enable fast and accurate identification of rotary axis geometric errors, an identification method of position-independent geometric errors in the rotary axes of five-axis machine tools based on ballbar under three installation modes is proposed. By installing the center of the cutter ball at the intersection point of the A axis and the C axis centerlines and offsetting the workpiece ball in the X and Y directions, two measurement modes can be switched under a single installation mode by sequentially controlling the motion of each rotary axis. Through the three installation modes, eight position-independent geometric errors of the rotary axes are identified. This method features simple installation, requires no extension rods, and eliminates the need for rotary axis centerline identification, thereby improving measurement efficiency.
(2) The initial coordinates of the cutter ball and the workpiece ball in the RCS are established by computing the workpiece ball's coordinates through inverse matrix transformation. A comprehensive rod-length model, including ballbar installation errors, is developed based on homogeneous coordinate transformation. Simulation analyses are conducted to compare the preset values and the identified values. Results show that the residuals of eight position-independent geometric errors are minimal, demonstrating the high accuracy of the described method.
(3) In the identification experiment, the installation errors are measured using the digital micrometer and the ballbar, whereby the influence of installation errors on the cutter side is substantially eliminated. The effectiveness of the method provided herein is verified by comparing the ballbar length prediction errors. The maximum prediction error observed in four measurement experiments does not exceed 1 μm, demonstrating that the method provided herein can effectively identify the position-independent geometric errors of the rotary axes.

After the eight position-independent geometric errors of the rotary axes in a five-axis machine tool are identified using the method provided herein, the error compensation is conducted based on the identified eight position-independent geometric errors to improve the machining accuracy. This process mainly relies on the numerical control system of the machine tool to correct the identified errors.

The geometric errors of the machine tool are caused by imperfections during the manufacturing and assembly processes. These errors are systematic and predictable and measurable to a certain extent. The present disclosure provides a method for accurately identifying such errors. After these errors (e.g., position deviations of the A and C axes (δ_{ya}, δ_{za}, δ_{xc}, and δ_{yc}) and the perpendicularity errors (δ_{ya}, S_{za}, S_{xc}, and S_{yc}) have been precisely quantified, the error compensation can be performed via software within the machine tool's numerical control system.

The compensation procedure is performed through the following steps.

### 1. Data Input

The precisely-identified eight geometric error values, obtained by fitting using MATLAB functions, are input into the numerical control system of the machine tool, which are equipped with an error compensation module.

### 2. Establishment of a Compensation Model (Provided by Numerical Control System)

A mathematical model inverse to the error model described herein is established by the numerical control system based on the input error values. This compensation model can calculate the instantaneous position and orientation deviations caused by these geometric errors during the relative motion between the cutter and the workpiece.

### 3. Real-Time Correction

During the part machining process, deviations caused by geometric errors are calculated in real time by the numerical control system based on the current axis positions. A corresponding correction command is automatically generated and superimposed on the nominal axis motion commands. For example, if a specific positional deviation in the Y direction is known to occur when the A axis rotates by 30°, a small compensating movement in the opposite direction is commanded for the Y axis to cancel out the deviation.

### 4. Accuracy Improvement

Through such real-time compensation, the actual motion trajectory of the machine tool is made closer to the ideal theoretical trajectory. As a result, machining defects caused by geometric errors of the rotary axes are eliminated or significantly reduced, thereby improving the overall machining accuracy of the machine tool.

### Verification and Advantages

The effectiveness of the method provided herein is validated through simulation and experimental tests. Simulation results show that the residuals between the identified values and preset values are minimal. In practical experiments, the maximum ballbar length prediction error based on the identification results does not exceed 1 μm. This indicates that the identified error data possess high accuracy, providing a reliable foundation for subsequent precise compensation.

The advantage of the method disclosed herein lies in its ability to improve machine tool accuracy not through time-consuming and labor-intensive physical adjustments or reassembly, but rather via a cost-effective and efficient software compensation approach. By accurately identifying and compensating for these difficult-to-measure rotary axis errors, the performance and precision of five-axis machine tool can be effectively enhanced when machining complex surfaces such as turbine blades and engine cylinder blocks.

Described embodiments are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. An identification method of position-independent geometric errors in rotary axes of a five-axis machine tool based on ballbar, comprising:
establishing coordinate systems in sequence based on a kinematic chain structure of a workpiece side of the five-axis machine tool; wherein the five-axis machine tool comprises three linear axes consisting of an X axis, a Y axis, and a Z axis, and two rotary axes consisting of an A axis and a C axis; the kinematic chain structure comprises a cutter chain R-Y-X-Z-T and a workpiece chain R-A-C-W; linear axes are not taken into consideration during establishment of the coordinate systems since it is only required to identify the position-independent geometric errors of the rotary axes; and
the coordinate systems are established through steps of:
establishing an A-axis coordinate system (ACS) at an intersection point between a centerline of the A axis and a centerline of the C axis;
establishing a C-axis coordinate system (CCS) at a center of a rotary table of the five-axis machine tool; and
establishing a workpiece coordinate system (WCS) and a reference coordinate system (RCS), wherein the WCS coincides with the CCS, the RCS coincides with the ACS, and Z-axis centerlines of the WCS, the CCS, the RCS and the ACS are colinear; and
performing error measurement on the five-axis machine tool under three installation modes, wherein in each of the three installation modes, a cutter ball B₁ is connected to a spindle of the five-axis machine tool via a first tool cup, and a workpiece ball B₂ is fixed to the rotary table of the five-axis machine tool via a second tool cup and a magnetic base, and the error measurement is performed through steps of:
in a first installation mode of the three installation modes, controlling the A axis or the C axis to move, and measuring four position errors to obtain a first ballbar rod-length model;
in a second installation mode of the three installation modes, controlling the A axis to move, and measuring two first perpendicularity errors to obtain a second ballbar rod-length model;
in a third installation mode of the three installation modes, controlling the C axis to move, and measuring two second perpendicularity errors to obtain a third ballbar rod-length model; and
calculating eight position-independent geometric errors of the two rotary axes by fitting using a MATrix LABoratory (MATLAB) function in combination with the first ballbar rod-length model, the second ballbar rod-length model and the third ballbar rod-length model based;
wherein the step of in the first installation mode, controlling the A axis or the C axis to move, and measuring the four position errors to obtain the first ballbar rod-length model is performed through steps of:
defining an initial coordinate of the cutter ball B₁ and an initial coordinate of the workpiece ball B₂ in the RCS respectively as:
$${}^{R} {P}_{B 1} = ( \begin{matrix}{e}_{x} \\ {e}_{y} \\ 0 \\ 1\end{matrix} ) , and \qquad ( 1 )$$
$${}^{R} {P}_{B 2} = ( \begin{matrix}{e}_{x} + {X}_{L} \\ {e}_{y} - {Y}_{L} \\ 0 \\ 1\end{matrix} ) ; \qquad ( 2 )$$
wherein eₓ and e_{y} represent installation errors of a center of the cutter ball B₁ in an X direction and a Y direction of the RCS, respectively; and X_{L} and Y_{L} represent offsets of a center of the workpiece ball B₂ with respect to the center of the cutter ball B₁ in the X direction and the Y direction, respectively;
in a case that only the A axis is controlled to move, performing circular motion of the workpiece ball B₂ about the A axis, and defining an actual transformation matrix from the ACS to the RCS as:
$${}_{A}^{R} T = [ \begin{matrix}1 & - {S}_{𝓏 a} & {S}_{y a} & 0 \\ {S}_{𝓏 a} & 1 & 0 & {δ}_{y a} \\ - {S}_{y a} & 0 & 1 & {δ}_{𝓏 a} \\ 0 & 0 & 0 & 1\end{matrix} ] \cdot [ \begin{matrix}1 & 0 & 0 & 0 \\ 0 & cos A & - sin A & 0 \\ 0 & sin A & cos A & 0 \\ 0 & 0 & 0 & 1\end{matrix} ] ; \qquad ( 3 )$$
calculating an initial coordinate of the workpiece ball B₂ in the ACS through inverse matrix transformation as:
$${}^{A} {P}_{B 2} = {}_{A}^{R} {T}^{- 1} \cdot {}^{R} {P}_{B 2} ; \qquad ( 4 )$$
obtaining an actual coordinate of the workpiece ball B₂ in the RCS through coordinate matrix transformation as:
$${}^{R} {P}_{B 2 \_ actual} {}_{A}^{R} T \cdot {}^{A} {P}_{B 2} ; \qquad ( 5 )$$
keeping the cutter ball B₁ fixed during the error measurement, such that a coordinate of the cutter ball B₁ in the RCS remains unchanged;
substituting the initial coordinate of the cutter ball B₁ and the actual coordinate of the workpiece ball B₂ into equations (6), (10), (13) and (16) followed by simplification and neglection of higher-order error terms, so as to obtain an actual length L_{A1} of the ballbar as:
$${L}_{A 1} = \vert {B}_{1} {B}_{2} \vert = \vert {}^{R} {P}_{B 2 \_ actual} {}^{R} {P}_{B 1} \vert = \sqrt{{[ {δ}_{{x}_{c}} - {e}_{x} + h \cdot ( {S}_{{y}_{a}} + {S}_{{y}_{c}} ) + ( L + {e}_{x} - {δ}_{{x}_{c}} - h \cdot ( {S}_{{y}_{a}} + {S}_{{y}_{c}} ) ) \cdot cos C + ( {δ}_{{y}_{a}} + {δ}_{{y}_{c}} - {e}_{y} - h \cdot {S}_{{x}_{c}} ) \cdot sin C ]}^{2} + {[ {δ}_{{y}_{a}} + {δ}_{{y}_{c}} - {e}_{y} - h \cdot {S}_{{x}_{c}} + ( L + {e}_{x} - {δ}_{{x}_{c}} - h \cdot ( {S}_{{y}_{a}} + {S}_{{y}_{c}} ) ) \cdot sin C - ( {δ}_{{y}_{a}} + {δ}_{{y}_{c}} - {e}_{y} - h \cdot {S}_{{x}_{c}} ) \cdot cos C ]}^{2} + {[ L ( ( {S}_{{y}_{a}} + {S}_{{y}_{c}} ) \cdot ( 1 - cos C ) + {S}_{{x}_{c}} \cdot sin C ]}^{2}} ; \qquad ( 6 )$$
in a case that only the C axis is controlled to move, performing circular motion of the workpiece ball B₂ about the C axis, and defining an actual transformation matrix from the CCS to the ACS as:
$${}_{C}^{A} T = [ \begin{matrix}1 & 0 & {S}_{yc} & {δ}_{xc} \\ 0 & 1 & - {S}_{xc} & {δ}_{yc} \\ - {S}_{yc} & {S}_{xc} & 1 & 0 \\ 0 & 0 & 0 & 1\end{matrix} ] \cdot [ \begin{matrix}cos C & - sin C & 0 & 0 \\ sin C & cos C & 0 & 0 \\ 0 & 0 & 1 & - {Z}_{AC} \\ 0 & 0 & 0 & 1\end{matrix} ] ; \qquad ( 7 )$$
wherein Z_{AC} indicates a distance between origins of the ACS and the CCS; 8 ya and da represent position deviations of the centerline of the A axis along a Y_{R} direction and a Z_{R} direction of the RCS of the five-axis machine tool, respectively; S_{ya} and S_{za} denote perpendicularity errors of the centerline of the A axis relative to a Y_{R} axis and a Z_{R} axis, respectively; &xc and δ_{yc} represent position deviations of the centerline of the C axis along X_{A} and Y_{A} directions of the ACS, respectively; and S_{xc} and S_{yc} denote perpendicularity errors of the centerline of the C axis relative to an X_{A} axis and a Y_{A} axis, respectively;
calculating an initial coordinate of the workpiece ball B₂ in the CCS as:
$${}^{C} {P}_{B 2} = {( {}_{A}^{R} T \cdot {}_{C}^{A} T )}^{- 1} \cdot {}^{R} {P}_{B 2} ; \qquad ( 8 )$$
calculating the actual coordinate of the workpiece ball B₂ in the RCS as:
$${}^{R} {P}_{B 2 \_ actual} = {}_{A}^{R} T \cdot {}_{C}^{A} T \cdot {}^{C} {P}_{B 2} ; \qquad ( 9 )$$
and obtaining an actual length L_{C1} of the ballbar based on the initial coordinate of the cutter ball B₁ and the actual coordinate of the workpiece ball B₂ as:
$${L}_{c 1} = \vert {B}_{1} {B}_{2} \vert = \vert {}^{R} {P}_{B 2 \_ actual} {}^{R} {P}_{B 1} \vert = \sqrt{{[ {δ}_{{x}_{c}} - {e}_{x} + h \cdot ( {S}_{{y}_{a}} + {S}_{{y}_{c}} ) + ( L + {e}_{x} - {δ}_{{x}_{c}} - h \cdot ( {S}_{{y}_{a}} + {S}_{{y}_{c}} ) ) \cdot cos C + ( {δ}_{{y}_{a}} + {δ}_{{y}_{c}} - {e}_{y} - h \cdot {S}_{{x}_{c}} ) \cdot sin C ]}^{2} + {[ {δ}_{{y}_{a}} + {δ}_{{y}_{c}} - {e}_{y} - h \cdot {S}_{{x}_{c}} + ( L + {e}_{x} - {δ}_{{x}_{c}} - h \cdot ( {S}_{{y}_{a}} + {S}_{{y}_{c}} ) ) \cdot sin C - ( {δ}_{{y}_{a}} + {δ}_{{y}_{c}} - {e}_{y} - h \cdot {S}_{{x}_{c}} ) \cdot cos C ]}^{2} + {[ L ( ( {S}_{{y}_{a}} + {S}_{{y}_{c}} ) \cdot ( 1 - cos C ) + {S}_{{x}_{c}} \cdot sin C ]}^{2}} ; \qquad ( 10 )$$
the step of in the second installation mode, controlling the A axis to move, and measuring the two first perpendicularity errors to obtain the second ballbar rod-length model is performed through steps of:
in a case that only the A axis is controlled to move, due to a change in an installation position of the ballbar, changing the initial coordinate of the cutter ball B₁ and the initial coordinate of the workpiece ball B₂ respectively into:
$${}^{R} {P}_{B 1} = ( \begin{matrix}{e}_{x} + l \\ {e}_{y} \\ 0 \\ 1\end{matrix} ) , and \qquad ( 11 )$$
$${}^{R} {P}_{B 2} = ( \begin{matrix}{e}_{x} + l \\ {e}_{y} - L \\ 0 \\ 1\end{matrix} ) ; \qquad ( 12 )$$
wherein I denotes a distance from the center of the cutter ball B₁ to the centerline of the C axis, and L denotes a nominal length of the ballbar;
calculating the actual coordinate of the workpiece ball B₂ in the RCS in the same way as the first installation mode to obtain an actual length L_{A2} of the ballbar as:
$${L}_{A 2} = \sqrt{{[ L ( {S}_{𝓏 a} \cdot cos A - {S}_{ya} \cdot sin A - {S}_{𝓏 a} ) ]}^{2} + {[ {δ}_{ya} + l \cdot {S}_{𝓏 a} - {e}_{y} + ( {δ}_{𝓏 a} + l \cdot {S}_{ya} ) sin A - ( L + {δ}_{ya} + l \cdot {S}_{𝓏 a} - {e}_{y} ) \cdot cos A ]}^{2} + {[ {δ}_{𝓏 a} - l \cdot {S}_{ya} - ( {δ}_{𝓏 a} - l \cdot {S}_{ya} ) \cdot cos A - ( L + {δ}_{ya} + l \cdot {S}_{𝓏 a} - {e}_{y} ) \cdot sin A ]}^{2}} ; \qquad ( 13 )$$
and
the step of in the third installation mode, controlling the C axis to move, and measuring the two second perpendicularity errors to obtain the third ballbar rod-length model is performed through steps of:
only controlling the C axis to move, and defining the initial coordinate of the cutter ball B₁ and the initial coordinate of the workpiece ball B₂ respectively as:
$${}^{R} {P}_{B 1} = ( \begin{matrix}{e}_{x} \\ {e}_{y} \\ h \\ 1\end{matrix} ) , and \qquad ( 14 )$$
$${}^{R} {P}_{B 2} = ( \begin{matrix}{e}_{x} + L \\ {e}_{y} \\ h \\ 1\end{matrix} ) ; \qquad ( 15 )$$
wherein h denotes a distance from the center of the cutter ball B₁ to the centerline of the A axis; and
calculating the actual coordinate of the workpiece ball B₂ in the RCS, so as to obtain an actual length Les of the ballbar as:
$${L}_{c 3} = \sqrt{{[ {δ}_{{x}_{c}} - {e}_{x} + h \cdot ( {S}_{{y}_{a}} + {S}_{{y}_{c}} ) + ( L + {e}_{x} - {δ}_{{x}_{c}} - h \cdot ( {S}_{{y}_{a}} + {S}_{{y}_{c}} ) ) \cdot cos C + ( {δ}_{{y}_{a}} + {δ}_{{y}_{c}} - {e}_{y} - h \cdot {S}_{{x}_{c}} ) \cdot sin C ]}^{2} + {[ {δ}_{{y}_{a}} + {δ}_{{y}_{c}} - {e}_{y} - h \cdot {S}_{{x}_{c}} + ( L + {e}_{x} - {δ}_{{x}_{c}} - h \cdot ( {S}_{{y}_{a}} + {S}_{{y}_{c}} ) ) \cdot sin C - ( {δ}_{{y}_{a}} + {δ}_{{y}_{c}} - {e}_{y} - h \cdot {S}_{{x}_{c}} ) \cdot cos C ]}^{2} + {[ L ( ( {S}_{{y}_{a}} + {S}_{{y}_{c}} ) \cdot ( 1 - cos C ) + {S}_{{x}_{c}} \cdot sin C ]}^{2}} . \qquad ( 16 )$$
